(19) United States
(12) Patent Application Publication
(10) Pub. No.: US 2025/0101201 A1
(43) Pub. Date: Mar. 27, 2025

(54) POLYMER COMPOSITIONS STABILIZED WITH ORGANODISULFIDE BLENDS

(71) Applicant: ARKEMA INC., KING OF PRUSSIA, PA (US)

(72) Inventor: CARLOS F. BUITRAGO, KING OF PRUSSIA, PA (US)

(21) Appl. No.: 18/406,815

(22) PCT Filed: Apr. 7, 2022
(86) PCT No.: PCT/US2022/023787

§ 371 Date: Jan. 8, 2024

Related U.S. Application Data
(60) Provisional application No. 63/218,526, filed on Jul. 6, 2021.

(51) Int. Cl. C08K 5/372; C08K 5/05

(52) U.S. Cl. CPC C08K 5/372; C08K 5/05

(57) ABSTRACT

Organodisulfides blends having heterogenous moieties of carbon chain length from 8 to 18 are useful stabilizers for polymer compositions, wherein the tendency of a polymer to degrade when exposed to environmental conditions such as heat, light and oxygen may be ameliorated by the incorporation of the heterogeneous organodisulfide blend.

### FIELD OF THE INVENTION

The invention relates to polymer compositions that have been stabilized with organodisulfide blends.

### BACKGROUND OF THE INVENTION

Although polymers are useful materials for the fabrication of various different types of finished articles, they are generally susceptible to degradation at elevated temperatures such as those employed during processing of a polymer or those encountered during normal use of a polymeric article intended to be exposed to relatively harsh conditions. Moreover, it is important in many end-use applications that polymeric articles remain functional and attractive in appearance over an extended service life, even if they are not subjected to extreme environmental stresses. Decomposition of a polymer can result in undesirable changes in the appearance and the physical and mechanical properties of the polymeric article. For these reasons, stabilizers of various types are typically incorporated into polymers in order to enhance their resistance to degradation. However, polymer stabilization is still an empirical art and generally it is not possible to predict with reasonable certainty whether a given additive will or will not be effective as a stabilizer. Moreover, compounds which suitably stabilize one type of polymer may not exhibit similar effects when incorporated into other types of polymers.

Accordingly, the development of alternative polymer stabilization technologies would be highly desirable.

### SUMMARY OF THE INVENTION

A polymer composition comprised of at least one polymer is stabilized by incorporating therein an organodisulfide blend stabilizer component. The resulting stabilized polymer composition exhibits improved resistance to degradation (in particular, at elevated temperatures), as compared to a polymer composition which does not contain any stabilizer. The presence of the organodisulfide blend stabilizer in the polymer results in an increased stability of the polymer towards typical decompositional stresses such as heat or light from processing or weathering. Such stabilization effects can be exemplified by a more consistent melt flow index during processing and a reduced yellowness index.

### BRIEF DESCRIPTION OF THE FIGURES

FIGS. 1-4 are graphic representations of certain experimental results, as further explained in the Examples.

FIG. 5 is photographs of ethylene-vinyl acetate copolymer stabilized with different thermal stabilizer packages, including organodisulfide blends, as explained in Example 3.

### DETAILED DESCRIPTION OF CERTAIN EMBODIMENTS OF THE INVENTION

### Organodisulfides

The stabilized polymer compositions of the present invention are comprised of at least one polymer and an organodisulfide blend stabilizer component. The organodisulfide blend stabilizer may be used in combination with an antioxidant such as phenolic compound pentaerythritol tetrakis(3-(5,di-tert-cutyl-4-hydroxyphernyl) propionate (Irganox® 1010) and 3,5-di-tert-butyl-4-hydroxyhydrocinnamate (Irganox® 1076). Such organodisulfide blends have been found to be particularly effective in improving the stability of polymers, especially with respect to their thermal stability (i.e., their ability to resist degradation when heated). Generally speaking, homogenous organodisulfides (i.e., compounds corresponding to the general formula R—SS—R, where each or substantially all R groups are the same organic moiety) do not provide the same level of polymer stabilization as the analogous non-homogenous organodisulfides (R—SS—R) where the R groups are varied organic moieties. The use of higher organopolysulfides (e.g., organopentasulfides R—SSSSS—R and organohexasulfides R—SSSSSS—R) as stabilizers in polymer compositions has been found to generally not be suitable, as the presence of such higher organopolysulfides often leads to severe odor issues and problems with the formation of elemental sulfur when the polymer compositions are heated. However, small amount of impurities including higher organopolysulfides may be present without detrimental impact on the present invention.

For these reasons, in various advantageous embodiments of the present invention, the organodisulfide blend stabilizer component present in the stabilized polymer composition is characterized by having a total content of organopolysulfides and other materials other than organodisulfide blends i.e. impurities, of about 10% or less, preferably 5% or less and more preferably 1% or less by weight, based on the total weight of organopolysulfides (i.e., organodisulfide blends+impurities) present in the stabilized polymer composition. The impurities, may comprise organopolysulides, mercaptans such as tertiary dodecyl mercaptan, sulfides and unreacted materials from the production of the organodisulfide blend stabilizer component.

In the context of the present invention, an organodisulfide is considered to be a compound containing at least one disulfide linkage (—SS—) interposed between two organic moieties, wherein the organic moieties are predominately different from each other. That is, the organic moieties of a small percentage of the organodisulfides may be the same without deviating from the present invention. The organodisulfide blends of the present invention are made up of organodisulfides substituted with a variety of organic moieties having from 8 to 18 carbon atoms, preferably from 9 to 15 carbon atoms. For example, the organodisulfide blend stabilizer component may comprise compounds corresponding to the general structures R¹—SS—R² and R³—SS—R⁴ and R¹—SS-Q-SS—R² and R³—SS-Q-SS—R⁴, wherein each R and Q is an organic moiety and R¹, R², R³ and R⁴ are predominately different and have carbon chain lengths from 8 to 18, preferably from 9 to 15.

The structures and identities of the organic moieties having carbon chain lengths from 8 to 18, preferably from 9 to 15 present in the organodisulfides blend component, are varied and selected as may be needed to improve or modify the compatibility of the organodisulfide blend stabilizer component with the polymer matrix in which it is incorporated. Without wishing to be bound by theory, it is believed that the organic moieties may assist in dispersing and/or solubilizing the organodisulfide blend stabilizer component in the polymer composition. Accordingly, the organic moieties may be chosen depending upon the polymer to be stabilized.

Suitable organic moieties include, for example, alkyl groups, aryl groups, and/or aralkyl groups, including substituted and heteroatom-containing variants thereof as will be explained in more detail subsequently.

In one aspect of the invention, the organodisulfide blend corresponds to the general formula (I):

R¹—S—S—R² (I)

wherein R¹, and R², are organic moieties having from 8 to 18 carbon atoms, preferably from 9 to 15 carbons, which are predominately different from each other. Each R group may optionally contain one or more ring structures, including alicyclic, aromatic and heteroaromatic ring structures. The organodisulfide blend components of the present invention are heterogeneous meaning that R¹ and R² are not predominantly all the same carbon chain length in contrast to a homogenous organodisulfides wherein R¹ and R² are substantially all the same carbon chain length.

Each R group comprising an organic moiety containing from 8 to 18 carbon atoms, preferably from 9 to 15 carbon atoms may optionally also containing one or more hydrogen atoms and/or one or more heteroatoms. The heteroatoms optionally present in one or both R groups may be, for example, N, O, S, Se, P, halide or the like or combinations thereof. The R groups in formula (I) will be described in further detail below. In formula (I), each of R moieties may, for example, represent an aliphatic hydrocarbon group that optionally has at least one substituent, an alicyclic hydrocarbon group that optionally has at least one substituent, an aromatic hydrocarbon group that optionally has at least one substituent, a heterocyclic group that optionally has at least one substituent, or an oxyalkylene-containing group. The term “aliphatic hydrocarbon group” encompasses an alkyl group, an alkenyl group and an alkynyl group.

Examples of an “alkyl group” include a methyl group, an ethyl group, an n-propyl group, an i-propyl group, an n-butyl group, an s-butyl group, an i-butyl group, a t-butyl group, an n-pentyl group, an n-hexyl group, a nonyl group, an i-nonyl group, a decyl group, a lauryl group, a tridecyl group, a myristyl group, a pentadecyl group, a palmityl group, a heptadecyl group, and a stearyl group. A C₆-C₂₅ or C₈-C₁₆ alkyl group may be used, for example. Examples of an “alkenyl group” include a vinyl group, a 1-propenyl group, a 2-propenyl group, a 1-butenyl group, a 2-butenyl group, a 3-butenyl group, a 1-methyl-2-propenyl group, a 2-methyl-2-propenyl group, a 1-pentenyl group, a 2-pentenyl group, a 3-pentenyl group, a 4-pentenyl group, a 1-methyl-2-butenyl group, a 2-methyl-2-butenyl group, a 1-hexenyl group, a 2-hexenyl group, a 3-hexenyl group, a 4-hexenyl group, a 5-hexenyl group, a heptenyl group, an octenyl group, a decenyl group, a pentadecenyl group, an eicosenyl group, and a tricosenyl group. A C₆-C₂₅ alkenyl group may be used, for example.

Examples of an “alkynyl group” include an ethynyl group, a 1-propynyl group, a 2-propynyl group, a 1-butynyl group, a 2-butynyl group, a 3-butynyl group, a 1-methyl-2-propynyl group, a 2-methyl-2-propynyl group, a 1-pentynyl group, a 2-pentynyl group, a 3-pentynyl group, a 4-pentynyl group, a 1-methyl-2-butynyl group, a 2-methyl-2-butynyl group, a 1-hexynyl group, a 2-hexynyl group, a 3-hexynyl group, a 4-hexynyl group, a 5-hexynyl group, a 1-heptynyl group, a 1-octynyl group, a 1-decynyl group, a 1-pentadecynyl group, a 1-eicosynyl group, and a 1-tricosynyl group. A C₆-C₂₅ alkynyl group may be used, for example. The term “alicyclic hydrocarbon group” refers to a monocyclic or polycyclic alkyl group, alkenyl group, and the like, and examples thereof include a cyclopropyl group, a cyclobutyl group, a cyclopentyl group, a cyclohexyl group, a cycloheptyl group, a cyclooctyl group, a cyclododecyl group, a bicyclooctyl group, a bicycloheptyl group, a norbomyl group, an adamantyl group, a 2-cyclopropenyl group, a 2-cyclopentenyl group, and a 4-cyclohexenyl group. A C₃-C₈ cycloalkyl group may be used, for example.

The term “aromatic hydrocarbon group” means a monocyclic or polycyclic aryl group. Here, in the case of a polycyclic aryl group, the term aromatic hydrocarbon group also encompasses a partially saturated group in addition to a fully unsaturated group. Examples thereof include a phenyl group, a naphthyl group, an azulenyl group, an indenyl group, an indanyl group, and a tetralinyl group. A C₆-C₁₀ aryl group may be used, for example.

The term “heterocyclic group” means a 5- to 7-membered aromatic heterocycle, saturated heterocycle or unsaturated heterocycle having 1 to 4 nitrogen atoms, oxygen atoms or sulfur atoms as a hetero atom(s), or a condensed heterocycle in which any of these heterocycles is condensed with another carbocyclic (e.g., benzene) or heterocyclic ring. Examples thereof include a furan-2-yl group, a furan-3-yl group, a thiophen-2-yl group, a thiophen-3-yl group, a pyrrol-1-yl group, a pyrrol-2-yl group, a pyridin-2-yl group, a pyridin-3-yl group, a pyridin-4-yl group, a pyrazin-2-yl group, a pyrazin-3-yl group, a pyrimidin-2-yl group, a pyrimidin-4-yl group, a pyridazin-3-yl group, a pyridazin-4-yl group, a 1,3-benzodioxol-4-yl group, a 1,3-benzodioxol-5-yl group, a 1,4-benzodioxan-5-yl group, a 1,4-benzodioxan-6-yl group, a 3,4-dihydro-2H-1,5-benzodioxepin-6-yl group, a 3,4-dihydro-2H-1,5-benzodioxepin-7-yl group, a 2,3-dihydrobenzofuran-4-yl group, a 2,3-dihydrobenzofuran-5-yl group, a 2,3-dihydrobenzofuran-6-yl group, a 2,3-dihydrobenzofuran-7-yl group, a benzofuran-2-yl group, a benzofuran-3-yl group, a benzothiophen-2-yl group, a benzothiophen-3-yl group, a quinoxalin-2-yl group, a quinoxalin-5-yl group, an indol-1-yl group, an indol-2-yl group, an isoindol-1-yl group, an isoindol-2-yl group, an isobenzofuran-1-yl group, an isobenzofuran-4-yl group, a chromen-2-yl group, a chromen-3-yl group, an imidazol-1-yl group, an imidazol-2-yl group, an imidazol-4-yl group, a pyrazol-1-yl group, a pyrazol-3-yl group, a thiazol-2-yl group, a thiazol-4-yl group, an oxazol-2-yl group, an oxazol-4-yl group, an isoxazol-3-yl group, an isoxazol-4-yl group, a pyrrolidin-2-yl group, a pyrrolidin-3-yl group, a benzoimidazol-1-yl group, a benzoimidazol-2-yl group, a benzothiazol-2-yl group, a benzothiazol-4-yl group, a benzoxazol-2-yl group, a benzoxazol-4-yl group, a quinolin-2-yl group, a quinolin-3-yl group, an isoquinolin-1-yl group, an isoquinolin-3-yl group, a 1,3,4-thiadiazol-2-yl group, a 1,2,3-triazol-1-yl group, a 1,2,3-triazol-4-yl group, a tetrazol-1-yl group, a tetrazol-2-yl group, an indolin-4-yl group, an indolin-5-yl group, a morpholin-4-yl group, a piperazin-2-yl group, a piperidin-2-yl group, a 1,2,3,4-tetrahydroquinolin-5-yl group, a 1,2,3,4-tetrahydroquinolin-6-yl group, a 1,2,3,4-tetrahydroisoquinolin-5-yl group, and a 1,2,3,4-tetrahydroisoquinolin-6-yl group. In one embodiment, R is a 1,3,4-thiadiazole group.

The term “ether-containing group” means an organic moiety containing one or more ether linkages, such as, for example, an oxyalkylene-containing group. An oxyalkylene-containing group may be a group that contains at least one moiety having general structure —O—(CH₂)ₒ— wherein o is an integer of at least 1 (e.g., 1, 2, 3, 4, etc.) and one or more of the hydrogen atoms in the CH₂ moieties may be replaced with a substituent such as an alkyl group (e.g., methyl or ethyl), aryl group or heterocyclic moiety.

Particularly advantageous examples of organodisulfide blends which can be utilized in the present invention include, but are not limited to:

Dialkyldisulfides, in particular organodisulfides in particular those having structure R¹—S—S—R², wherein R¹ and R² are independently selected from C₈-C₁₈ alkyl groups, wherein R¹ and R² are predominantly different, corresponding to the foregoing structures. Preferred dialkyldisulfides are of the formula R⁸—SS—R⁹, where R⁸ and R⁹ are predominantly different and are predominantly non-linear C₆ to C₁₅ aliphatic moieties.

Aromatic disulfides of the following formula:

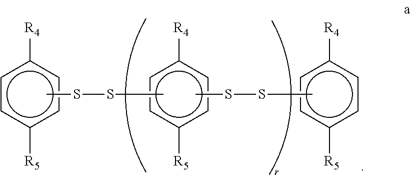

wherein R⁴ is predominantly tert-butyl or tert-amyl, R₅ is hydroxyl (—OH), with the aromatic rings being optionally substituted in one or more positions with substituents other than hydrogen (e.g., halogen, alkyl, alkoxy), including combinations of such aromatic disulfides. In one embodiment of the invention, none of the aromatic rings are substituted at positions ortho to the R₅ (hydroxyl) group with substituents other than hydrogen. Vultac® 2 and Vultac® 3, which are products sold by The Arkema Group, are examples of such suitable aromatic disulfides (Vultac® 2: r=1, R⁴=t-amyl; Vultac® 3: r=3-5, each R⁴=t-amyl).

Organodisulfides useful in the present invention are well known in the art and may be prepared by any appropriate method. Suitable organodisulfides are also available from commercial sources, such as The Arkema Group.

### Polymers

The polymer employed in the present invention may be any type of polymer known in the art and may be, for example, a thermoplastic polymer, a thermoset polymer, an elastomer, a thermoplastic elastomer, a non-cross-linked polymer, or a cross-linked polymer. Mixtures, blends or alloys of two or more different types of polymer may also be used.

The invention is particularly useful for the stabilization of thermoplastics such as polyolefins (also referred to as polyolefin resins, e.g., polyethylene, polypropylene), styrenic resins (e.g., polystyrenes), acrylic resins (also referred to as polyacrylates, e.g., polymethyl methacrylates) and polyacetals (e.g., polyoxymethylene resins).

In general, polymers which can be stabilized in accordance with the present invention include, but are not limited to:
A. Polymers of monoolefins and diolefins, for example polyethylenes (which optionally can be cross-linked), polypropylenes, polyisobutylene, polybutene-1, polymethyl-pentene-1, polyisoprene or polybutadiene, as well as polymers of cycloolefins, for instance of cyclopentene or norbornene.
B. Mixtures of the polymers mentioned under A), for example mixtures of polypropylene with polyisobutylene.
C. Copolymers of monoolefins and diolefins with each other or with other vinyl monomers, such as, for example, ethylene/propylene, propylene/butene-1, propylene/isobutylene, ethylene/butene-1, propylene/butadiene, isobutylene/isoprene, ethylene/alkyl acrylates, ethylene/alkyl methacrylates, ethylene/vinyl acetate or ethylene/acrylic acid copolymers and their salts (ionomers) and terpolymers of ethylene with propylene and a diene, such as hexadiene, dicyclopentadiene or ethylidene-norbornene.
D. Polystyrene, poly-(p-methylstyrene).
E. Ethylene-vinyl acetate copolymer.
F. Copolymers of styrene or methylstyrene with dienes or acrylic derivatives, such as, for example, styrene/butadiene, styrene/acrylonitrile, styrene/ethyl methacrylate, styrene/butadiene/ethyl acrylate, styrene/acrylonitrile/methyl acrylate; mixtures of high impact strength from styrene copolymers and another polymer, such as, for example, from a polyacrylate, a diene polymer or an ethylene/propylene/diene terpolymer; and block polymers of styrene, such as, for example, styrene/butadiene/styrene, styrene/isoprene/styrene, styrene/ethylene/butylene/styrene or styrene/ethylene/propylene/styrene.
G. Graft copolymers of styrene, such as, for example, styrene on polybutadiene, styrene and acrylonitrile on polybutadiene, styrene and alkyl acrylates or methacrylates on polybutadiene, styrene and acrylonitrile on ethylene/propylene/diene terpolymers, styrene and acrylonitrile on polyacrylates or polymethacrylates, styrene and acrylonitrile on acrylate/butadiene copolymers, as well as mixtures thereof with the copolymers listed under E), for instance the copolymer mixtures known as ABS-, MBS-, ASA- or AES-polymers.
H. Halogen-containing polymers, including chloropolymers and fluoropolymers, such as polychloroprene, chlorinated rubbers, chlorinated or sulfochlorinated polyethylene, epichlorohydrin homo- and copolymers, polymers from halogen-containing vinyl compounds, as for example, polyvinylchloride, polyvinylidene chloride, polyvinyl fluoride, polyvinylidene fluoride, as well as copolymers thereof, as for example, vinyl chloride/vinylidene chloride, vinyl chloride/vinyl acetate, vinylidene chloride/vinyl acetate copolymers, or vinyl fluoride/vinyl ether copolymers.
I. Polymers which are derived from alpha, beta-unsaturated acids and derivatives thereof (e.g., esters of alpha, beta-unsaturated acids), such as polyacrylates and polymethacrylates, polyacrylamide and polyacrylonitrile.
J. Copolymers from the monomers mentioned under H) with each other or with other unsaturated monomers, such as, for instance, acrylonitrile/butadiene, acrylonitrile/alkyl acrylate, acrylonitrile/alkoxyalkyl acrylate or acrylonitrile/vinyl halogenide copolymers or acrylonitrile/alkyl methacrylate/butadiene terpolymers.
K. Polymers which are derived from unsaturated alcohols and amines, or acyl derivatives thereof or acetals thereof, such as polyvinyl alcohol, polyvinyl acetate, polyvinyl stearate, polyvinyl benzoate, polyvinyl maleate, polyvinyl-butyral, polyallyl phthalate or polyallyl-melamine.
L. Homopolymers and copolymers of cyclic ethers, such as polyalkylene glycols, polyethylene oxide, polypropylene oxide or copolymers thereof with bis-glycidyl ethers.
M. Polyacetals, such as polyoxymethylene and those polyoxymethylenes which contain ethylene oxide as comonomer.
N. Polyphenylene oxides and sulfides, and mixtures of polyphenylene oxides with polystyrene.
O. Polyurethanes which are derived from polyethers, polyesters or polybutadiens with terminal hydroxyl groups on the one side and aliphatic or aromatic polyisocyanates on the other side, as well as precursors thereof (polyisocyanates, polyols or prepolymers).
P. Polyamides and copolyamides which are derived from diamines and dicarboxylic acids and/or from aminocarboxylic acids or the corresponding lactams, such as polyamide 4, polyamide 6, polyamide 6/6, polyamide 6/10, polyamide 11, polyamide 12, poly-2,4,4-trimethylhexamethylene terephthalamide, poly-p-phenylene terephthalamide or poly-m-phenylene isophthalamide, as well as copolymers thereof with polyethers, such as for instance with polyethylene glycol, polypropylene glycol or polytetramethylene glycols.
Q. Polyureas, polyimides and polyamide-imides.
R. Polyesters which are derived from dicarboxylic acids and diols and/or from hydroxycarboxylic acids or the corresponding lactones, such as polyethylene terephthalate, polybutylene terephthalate, poly-1,4-dimethylol-cyclohexane terephthalate, poly-[2,2-(4-hydroxyphenyl)-propane]terephthalate and polyhydroxybenzoates as well as block-copolyether-esters derived from polyethers having hydroxyl end groups.
R. Polycarbonates.
S. Polysulfones, polyethersulfones and polyetherketones.
T. Cross-linked polymers which are derived from aldehydes on the one hand and phenols, ureas and melamines on the other hand, such as phenol/formaldehyde resins, urea/formaldehyde resins and melamine/formaldehyde resins.
U. Drying and non-drying alkyd resins.
V. Unsaturated polyester resins which are derived from copolyesters of saturated and unsaturated dicarboxylic acids with polyhydric alcohols and vinyl compounds as crosslinking agents, and also halogen-containing modifications thereof of low flammability.
W. Thermosetting acrylic resins, derived from substituted acrylic esters, such as epoxy-acrylates, urethane-acrylates or silicone-acrylates.
X. Alkyd resins, polyester resins or acrylate resins in admixture with melamine resins, urea resins, polyisocyanates or epoxide resins as crosslinking agents.
Y. Cross-linked epoxide resins which are derived from polyepoxides, for example from bis-glycidyl ethers or from cycloaliphatic diepoxides.
Z. Natural polymers, such as cellulose, rubber, gelatin and derivatives thereof which are chemically modified in a polymer homologous manner, such as cellulose acetates, cellulose propionates and cellulose butyrates, or the cellulose ethers, such as methyl cellulose.
AA. Mixtures of polymers as mentioned above, for example PP/EPDM, Polyamide 6/EPDM or ABS, PVC/EVA, PVC/ABS, PVC/MBS, PC/ABS, PBTP/ABS.
BB. Polysiloxanes.
CC. Polymers prepared from radiation curable compositions containing ethylenically unsaturated monomers and/or oligomers.

In general, the organodisulfides blends of the present invention may be employed in total amounts representing from about 0.001 to about 5% by weight of the stabilized composition, although this will vary with the particular polymer, formulation, stabilizer and application. An advantageous range is from about 0.001 to about 0.05%, by weight in total of organodisulfide blend.

The organodisulfide blend stabilizer component of the instant invention may readily be incorporated into a polymer by conventional techniques, at any convenient stage prior to the manufacture of shaped articles therefrom. For example, the organodisulfide blend stabilizer component may be mixed with the polymer in liquid form (using, for example, extrusion or compounding methods), or a suspension or emulsion of the organodisulfide blend stabilizer component may be mixed with a solution, suspension, or emulsion of the polymer. The organodisulfide blend stabilizer component of the instant invention may readily be incorporated into a polymer as a dry powder such as the organodisulfide blend stabilizer component which is encapsulated or the organodisulfide blend stabilizer component adsorbed on a porous substrate.

In general, the organodisulfide blend stabilizer component can be added to polymeric materials before, during or after the polymerization or cross-linking of said materials. The organodisulfide blend stabilizer component can be incorporated into the polymer(s) to be stabilized in a pure form, encapsulated in waxes, oils or polymers or adsorbed on a porous substrate. The organodisulfide blend stabilizer component may be compounded into virgin resins, into post-processed recovered scraps, or into polymer reclaimed or recycled from post-consumer goods. Where the organodisulfide blend stabilizer component is made up of more than one compound, the compounds may be combined with the polymer separately or as a pre-mixed blend.

### Other Components and Additives

The stabilized polymer compositions of the invention may optionally also contain one or more various conventional polymer additives, such as the following:
1. Antioxidants, such as alkylated monophenols, including hindered alkylated monophenols; alkylated hydroquinones; hydroxylated thiodiphenyl ethers; alkylidene-bisphenols, benzyl compounds; acylaminophenols; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; and amides of beta-(3,5-di-tert-butyl-4-hydroxyphenyl)-propionic acid.
2. UV absorbers and light stabilizers, such as 2-(2′-hydroxyphenyl)-benzotriazoles; 2-hydroxy-benzophenones; esters of optionally substituted benzoic acids; acrylates; nickel compounds;
   sterically hindered amines; oxalic acid diamides; and hydroxyphenyl-s-triazines.
3. Metal deactivators.
4. Phosphites and phosphonites.
5. Compounds which destroy peroxide.
6. Basic co-stabilizers, for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids for example Ca stearate, Zn stearate, Mg stearate, Na ricinoleate and K palmitate, antimony pyrocatecholate or zinc pyrocatecholate.
7. Nucleating agents, for example, 4-tert-butyl-benzoic acid, adipic acid, or diphenylacetic acid.
8. Fillers and reinforcing agents, for example, calcium carbonate, silicates, glass fibers, asbestos, talc, kaolin, mica, barium sulfate, metal oxides and hydroxides, carbon black, and graphite.
9. Other additives, for example, plasticizers, lubricants, emulsifiers, pigments, optical brighteners, flameproofing agents, fire retardants, anti-static agents, and blowing agents.

The stabilized polymer compositions of the present invention are useful for any of the applications in which polymer compositions are conventionally employed, such as the fabrication of articles such as containers, vehicle parts, electronic components, building components, appliance components, composites, coatings, pipes, films, sheets and the like, using techniques such as molding, casting, extrusion, sintering and so forth.

Various illustrative aspects of the invention may be summarized as follows:

Aspect 1: A stabilized polymer composition comprised of at least one polymer and an organodisulfide blend stabilizer component comprised of organodisulfides having the structures R¹—S(S)—R² wherein R¹ and R² are independently selected from C₈-C₁₈ organic groups and not all R¹ and R² have the same carbon chain length.

Aspect 2: The stabilized polymer composition of Aspect 1, wherein the C₉-C₁₄ organic groups are selected from the group consisting of alkyl groups, aromatic groups and heterocyclic groups.

Aspect 3: The stabilized polymer composition of Aspect 2, wherein R¹ and R² are independently selected from C₈-C₁₈ alkyl groups of different carbon chain lengths.

Aspect 4: The stabilized polymer composition of Aspect 1 to 3, wherein the organodisulfide blend stabilizer component comprises at least 90% by weight of the organodisulfides having the structures R¹—S(S)—R².

Aspect 5: The stabilized polymer composition of any of Aspects 1 to 4, wherein the at least one polymer comprises at least one thermoplastic.

Aspect 6: The stabilized polymer composition of any of Aspects 1 to 5, wherein the at least one polymer comprises at least one elastomer.

Aspect 7: The stabilized polymer composition of any of Aspects 1 to 5, wherein the at least one polymer is selected from the group consisting of styrenic resins, polyolefin resins, acrylic resins and polyoxymethylene resins.

Aspect 8: The stabilized polymer composition of any of Aspects 1 to 5, wherein the at least one polymer is selected from the group consisting of ethylene-vinyl acetate copolymer, polystyrenes, polymethyl methacrylates, polypropylenes and polyethylenes.

Aspect 9: The stabilized polymer composition of any of Aspects 1 to 8, wherein the stabilized polymer composition is comprised of from 0.001 to 5% by weight of the organodisulfide blend stabilizer component.

Aspect 10: The stabilized polymer composition of any of Aspects 1 to 9, wherein the stabilized polymer composition is additionally comprised of at least one stabilizer other than an organodisulfide blend stabilizer component.

Aspect 11: The stabilized polymer composition of Aspect 10, wherein the at least one stabilizer other than an organopolysulfide blend stabilizer component
is selected from the group consisting of antioxidants, antiozonants and UV stabilizers.

Aspect 12: The stabilized polymer composition of Aspect 10, wherein the antioxidants is a phenolic compound

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### Examples 1-2

### Methodology

Polymer and additive samples for thermal stability testing were prepared by compounding (mixing) at 188° C. by passing them twice through a single-screw compounding extruder with a screw speed of 30 Hz. Polymers were compounded with certain disulfide additives at varying levels. The processing testing consisted of five extrusion passes of each polymer and additive composition at 230° C. using a screw speed of 18.6 Hz. The performance of each stabilizing package during processing was evaluated by measurements of the melt flow index (MFI, measured at 230° C. and under 2.16 lb, according to ASTM D1238) and yellowness index (YI, according to ASTM E313).

Ten stabilizing chemical formulations were evaluated in an unstabilized polypropylene homopolymer via processing by extrusion. The ten formulations correspond to those in the Table 1:

TABLE 1

| AO 1010 | Ca Stearate | DtDDS | DnDDS | DnODS |
|---|---|---|---|---|
| (ppm) | (ppm) | (ppm) | (ppm) | (ppm) |
| 1000 | 500 | 0 | 0 | 0 |
| 1000 | 500 | 100 | 0 | 0 |
| 1000 | 500 | 250 | 0 | 0 |
| 1000 | 500 | 1000 | 0 | 0 |
| 1000 | 500 | 0 | 100 | 0 |
| 1000 | 500 | 0 | 250 | 0 |
| 1000 | 500 | 0 | 1000 | 0 |
| 1000 | 500 | 0 | 0 | 100 |
| 1000 | 500 | 0 | 0 | 250 |
| 1000 | 500 | 0 | 0 | 1000 |

In Table 1, AO 1010 is the phenolic primary antioxidant Irganox® 1010 (pentaerythritol tetrakis(3-(3,5-di-tert-cutyl-4-hydroxyphenyl) propionate available from BASF)). Ca Stearate is the residual catalyst scavenger calcium stearate. The disulfides are Di-tert dodecyl disulfide (DtDDS) a disulfide blend having R moieties of from 9 to 15 carbons; di-n dodecyl disulfide (DnDDS) a homogenous polydisulfide having R moieties of 12 carbon atoms and di-n-octadecyl disulfide (DnODS) a homogenous polydisulfide having R moieties of 18 carbon atoms. The data shows that the polydisulfide blend DtDDs provided decreased melt flow index and yellowness index with respect to the homogenous polydisulfides.

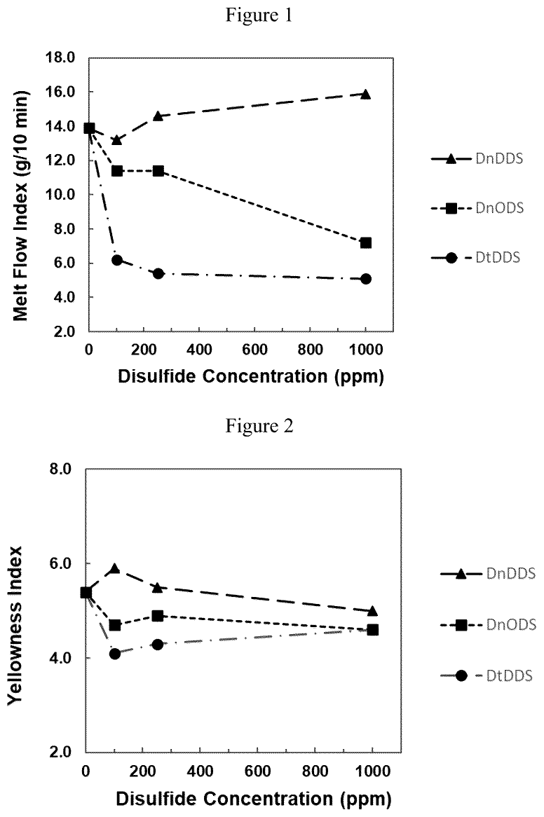

FIG. 1 shows the melt flow index (MFI) after 5 extrusions at 230° C. for DtDDS, DnDDS and DnODS. The DtDDS organodisulfide blend demonstrated superior performance at reducing the melt flow index over homogeneous organodisulfides DnDDS and DnODS. The DtDDs organodisulfide blend provided a lower Melt Flow Index at lower loadings.

FIG. 2 shows the yellowness index (YI) after 5 extrusions at 230° C. for DtDDS, DnDDS and DnODS. The DtDDS organodisulfide blend demonstrated superior performance at reducing the yellowness index over homogeneous organodisulfides DnDDS and DnODS. The DtDDs organodisulfide blend provided a lower yellowness index at lower loadings.

An organodisulfide blend in accordance with the present invention was also evaluated in comparison with a current commercial polymer stabilizer package comprising: 1,000 ppm AO 1010 (phenolic primary antioxidant Irganox® 1010 (pentaerythritol tetrakis(3-(3,5-di-tert-cutyl-4-hydroxyphenyl) propionate available from BASF)); 500 ppm Ca stearate; 1,000 ppm Irgafos® 168 (the phosphite process stabilizer tris(2,4-di-tert-butylphenyl) phosphite available from BASF); and 1,000 ppm DSTDP (the long-term, high-temperature antioxidant distearyl thiodipropionate).

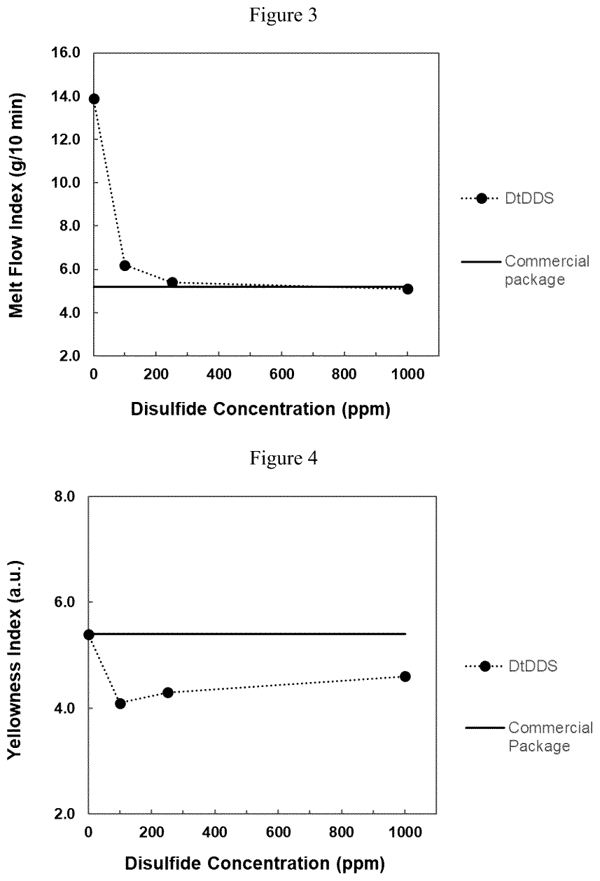

FIG. 3 shows the melt flow index (MFI) after 5 extrusions at 230° C. for DtDDs and the commercial stabilizer package.

FIG. 4 shows the yellowness index (YI) after 5 extrusions at 230° C. for DtDDs and the commercial stabilizer package.

The figures show that the heterogeneous organodisulfide blend of the present invention provides for lower melt flow index and yellowness index than corresponding homogeneous organodisulfides and a commercial polymer stabilizer package.

### Example 3

### Methodology

Commercial grade EVA (ethylene-vinyl acetate) copolymer containing 28% vinyl acetate and featuring Melt Flow Index of 3 g/10 min (2.16 lb at 190° C.) was compounded with antioxidants indicated in table 2 at 140° C. in a twin screw compounder with screw speed of 50 RPM. Aging experiments were carried out in an air convection oven at 160° C. for seven days.

TABLE 2

| | AO 1010 (ppm) | AO 1076 (ppm) | DtDDS (ppm) |
|---|---|---|---|
| Formulation (1) | 0 | 0 | 0 |
| Formulation (2) | 250 | 250 | 0 |
| Formulation (3) | 300 | 300 | 0 |
| Formulation (4) | 0 | 0 | 500 |
| Formulation (5) | 250 | 250 | 100 |

In Table 2, AO 1010 is the phenolic primary antioxidant Irganox® 1010 (pentaerythritol tetrakis(3-(3,5-di-tert-cutyl-4-hydroxyphenyl) propionate available from BASF)). AO 1076 is Octadecyl 3, 5-di-t-butyl-4-hydroxyhydrocinnamate. The disulfides are Di-tert dodecyl disulfide (DtDDS) a polydisulfide blend having R moieties of from 9 to 15 carbons

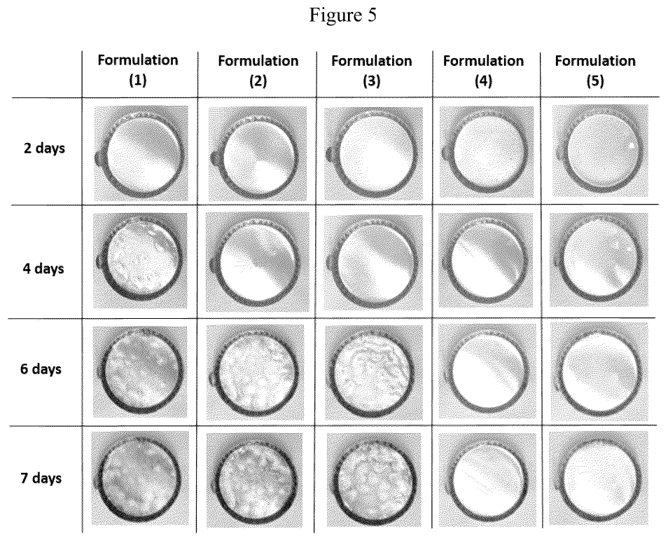

The data shows that Formulations 4 and 5 which contain the disulfide blend DtDDS provided enhanced protection against oxidation as evidenced by absence of bubbling and discoloration. Low amount of DtDDS such as in formulation 4 (500 ppm total loading), can exceed the performance of higher total loading of commercial alternatives such as in formulation 3 (600 ppm total loading). The photographs in FIG. 5 show the effect on stability over time.

What is claimed is:

1. A stabilized polymer composition comprised of at least one polymer and an organodisulfide blend stabilizer component comprised of organodisulfides having the structures R¹—S(S)—R² wherein R¹ and R² are independently selected from C₈-C₁₈ organic groups and not all R¹ and R² have the same carbon chain length.

2. The stabilized polymer composition of claim 1, wherein the C₈-C₁₈ organic groups are selected from the group consisting of alkyl groups, aromatic groups and heterocyclic groups.

3. The stabilized polymer composition of claim 2, wherein R¹ and R² are independently selected from C₈-C₁₈ alkyl groups of different carbon chain lengths

4. The stabilized polymer composition of claim 1, wherein the organodisulfide blend stabilizer component comprise at least 90% by weight of the organodisulfide having the structures R¹—S(S)—R².

5. The stabilized polymer composition of claim 1, wherein the at least one polymer comprises at least one thermoplastic.

6. The stabilized polymer composition of claim 1, wherein the at least one polymer comprises at least one elastomer.

7. The stabilized polymer composition of claim 1, wherein the at least one polymer is selected from the group consisting of styrenic resins, polyolefin resins, acrylic resins and polyoxymethylene resins.

8. The stabilized polymer composition of claim 1, wherein the at least one polymer is selected from the group consisting of ethylene-vinyl acetate copolymer polystyrenes, polymethyl methacrylates, polypropylenes and polyethylenes.

9. The stabilized polymer composition of claim 1, wherein the stabilized polymer composition is comprised of from 0.001 to 5% by weight of the organopolysulfide blend stabilizer component.

10. The stabilized polymer composition of claim 1, wherein the stabilized polymer composition is additionally comprised of at least one stabilizer other than an organopolysulfide blend stabilizer component.

11. The stabilized polymer composition of claim 10, wherein the at least one stabilizer other than an organopolysulfide blend stabilizer component is selected from the group consisting of antioxidants, antiozonants and UV stabilizers.

12. The stabilized polymer composition of claim 10, wherein the antioxidants is a phenolic compound.
